(19) United States
(12) Patent Application Publication
(10) Pub. No.: US 2002/0187021 A1
(43) Pub. Date: Dec. 12, 2002

(54) Hay bale pick-up device

(76) Inventor: Duane A. Drost, Harris, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 09/879,439

(22) Filed: Jun. 12, 2001

(51) Int. Cl. B60P 1/43

(52) U.S. Cl. 414/111; 414/469; 414/525.1; 414/533; 414/537

(57) ABSTRACT

A hay bale pick-up device having a trailer with a deck, side wall, side bar, front wall, and tail gate; a powered track with a front end terminating in an inclined ground engaging track for transporting hay bales onto the deck; and a means for laterally moving the side bar across the track to laterally move hay bales onto the deck.

### BACKGROUND OF THE INVENTION

In typical hay cutting operations, hay is cut and baled using well-known bailing machines that deposit the bales on the ground across a field. Traditionally, these smaller bales are manually collected for storage in a barn or loft. This traditional method can be time consuming and require additional manpower.

Devices have been developed for eliminating the need for manual labor to pick-up bales. For example, U.S. Pat. No. 4,372,722 by Van Horn and U.S. Pat. No. 3,251,485 by Fancher are both devices used for picking up hay bales. These devices, however, are complicated in both their construction and operation requiring many machined parts that are expensive to produce. In addition, because of many steps required during operation, the parts are susceptible to wear and breakage.

Therefore, a principal objective of this invention is to provide a hay bale pick-up device that is simple to manufacture and operate.

A further objective of this invention is to provide a hay bale pick-up device that is economic to manufacture requiring fewer parts.

### BRIEF SUMMARY OF THE INVENTION

The present invention generally comprises a trailer with a deck, a front wall, a tailgate, a side wall, and a side bar. A powered track extending longitudinally along one side of the deck has a forward end that terminates in an inclined ground engaging ramp that receives hay bales and transports the bales from the ground to a portion of the track on the deck where the bales are positioned in a row. When a row of bales is formed, a means for moving the side bar laterally is activated such that the side bar moves across the track portion of the deck to move the row of bales laterally until the trailer is completely loaded.

### BRIEF DESCRIPTION OF THE DRAWINGS

FIG. 1 is a perspective view of the hay bale pick-up device.

FIG. 2 is a side elevational view of the hay bale pick-up device.

FIG. 3 is a top plan view of the hay bale pick-up device.

FIG. 4 is an enlarged side elevational view of the hay bale pick-up device taken along line 4-4 of FIG. 2 with the check plate in an upwardly position.

FIG. 5 is an enlarged side elevational view of the hay bale pick-up device with the check plate in a down position; and

FIG. 6 is an exploded perspective view of a portion of the track of the hay bale pick-up device.

### DETAILED DESCRIPTION OF THE INVENTION

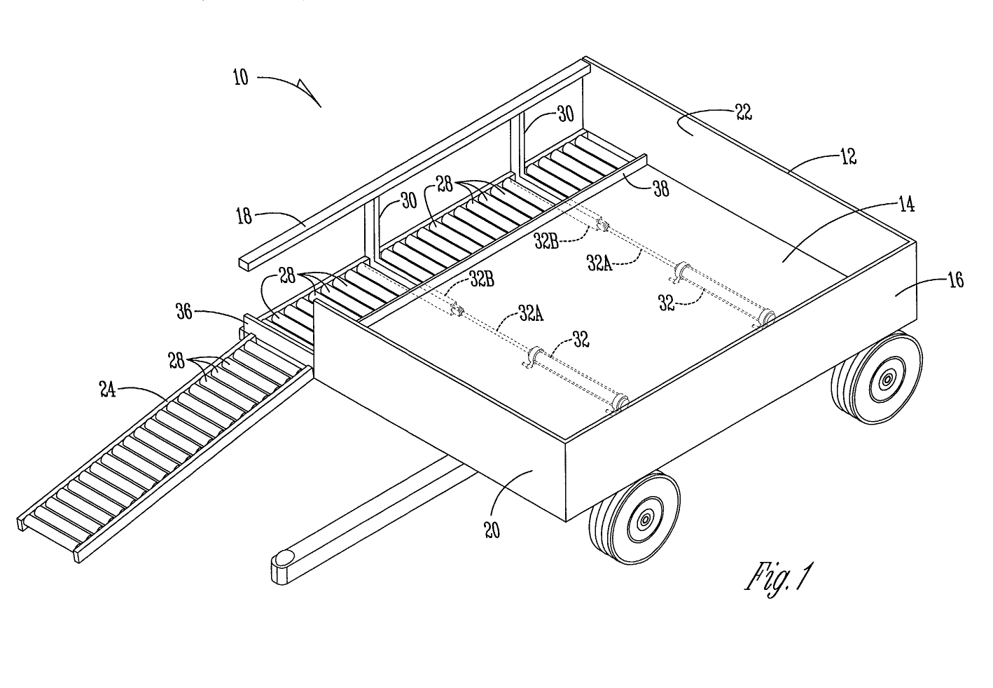

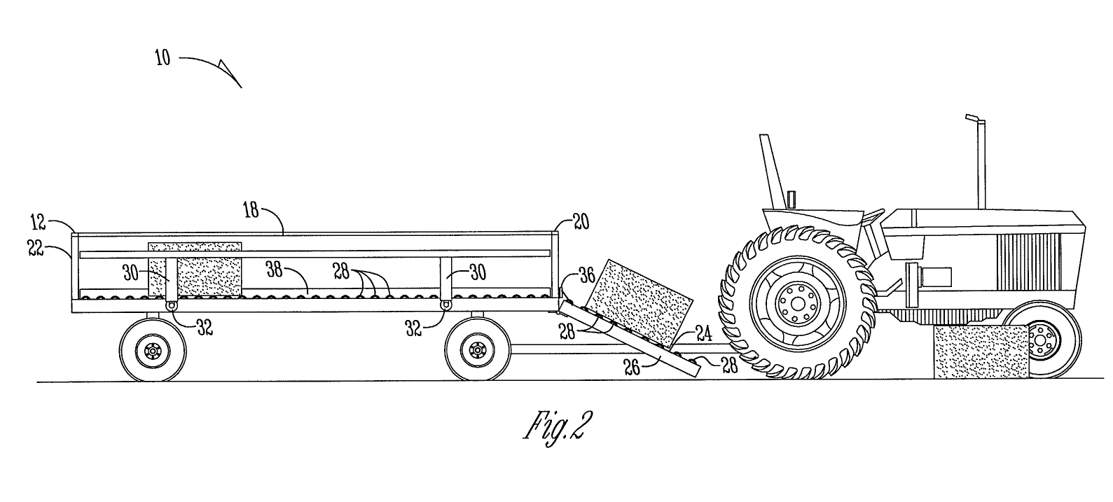

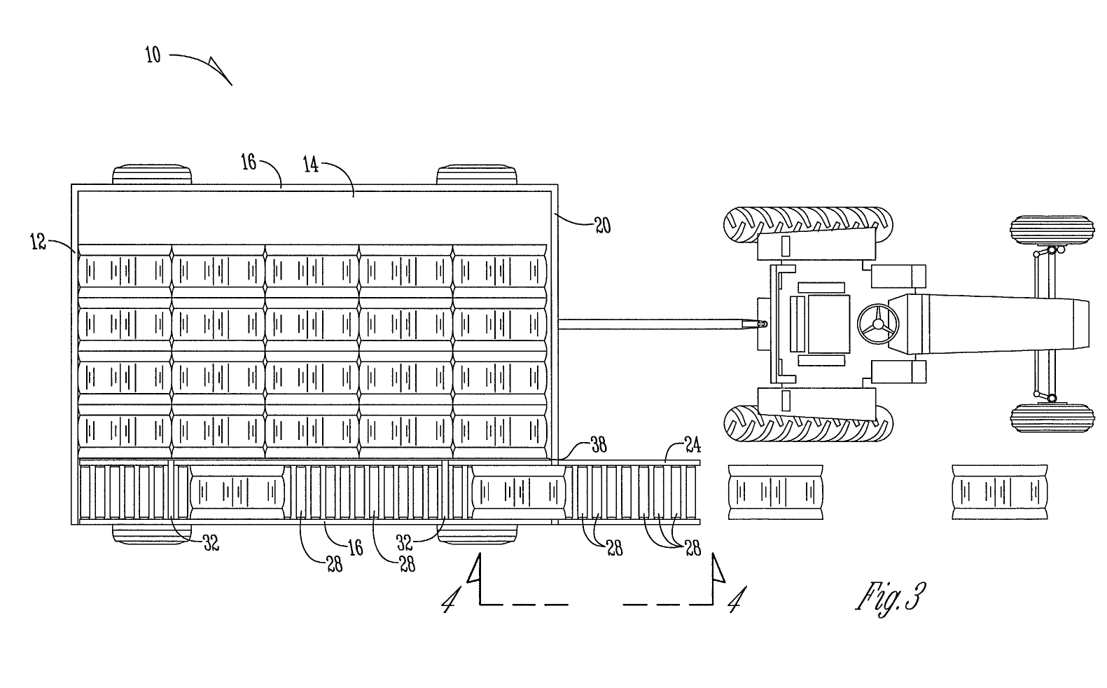

Referring to the drawings, the hay bale pick-up device is referred to generally by reference numeral 10. While this description outlines a device for picking-up hay bales, the device can also be used to pick-up other types of bales such as cotton bales. Referring to FIGS. 1-3, the device 10 has a trailer 12 that is supported for travel upon the ground. The trailer has a deck 14, a side wall 16, a side bar 18, a front wall 20, and a tail gate 22. Extending longitudinally along one side of the deck 14 is a powered track 24 that has a front end terminating in an inclined ground engaging ramp 26 for receiving hay bales. The track can be adapted to receive different types of bales including round, square and rectangular bales. A plastic floating skid plate (not shown) is attached to the lower end of the ramp 26 and extends rearwardly to prevent the ramp from gouging the ground. Also, to assist in guiding a bale onto and along the ramp are guide plates (not shown) on the outer edges of the ramp 26. The guide plates extend beyond the lower end of the ramp and are angled outwardly to funnel the hay bales toward and onto the ramp. The portion of the guide plates that extend along the outer edges of the ramp hold the bales in position while they are transported on the ramp. The track 24 successively transports hay bales from the ground up the ramp 26 to the deck 14 positioning the bales in a row. The track 24 can be of any conventional type capable of transporting the bales and in the embodiment shown in the drawings comprises a plurality of spaced rollers 28. In an alternative embodiment the portion of the track 24 on the ramp 26 is comprised of a pair of chains that extend longitudinally around the ramp 26 with a plurality of spikes that engage and hold the bales while transported on the ramp. The track 24 is powered by any conventional means including a separate motor or PTO (not shown).

When the deck portion of the track is filled with a row of bales the side bar 18 is activated to move laterally across the track 24 pushing the row of bales off the track 24 onto the deck 12 (FIG. 6). Preferred is a side bar 18 positioned six inches above the deck 12. In the embodiment shown in FIG. 6 the side bar 18 has vertical members 30 that extend downwardly below the deck where the members 30 are connected to cylinders 32 that extend horizontally under the deck 12. The cylinders 32, which can be of any conventional type including hydraulic cylinders, are connected to the lower surface of the deck 12 at our end and to the vertical members 30 at the other end through any convenient connection to piston rods 32A. The cylinders 32 can be powered by a separate motor (not shown). When activated, the cylinders 32 contract the piston rods 32A and pull the side bar 18 laterally such that the vertical members 30 fit between spaces in the rollers 28 and are pulled only to the inner edge 34 of the track 24.

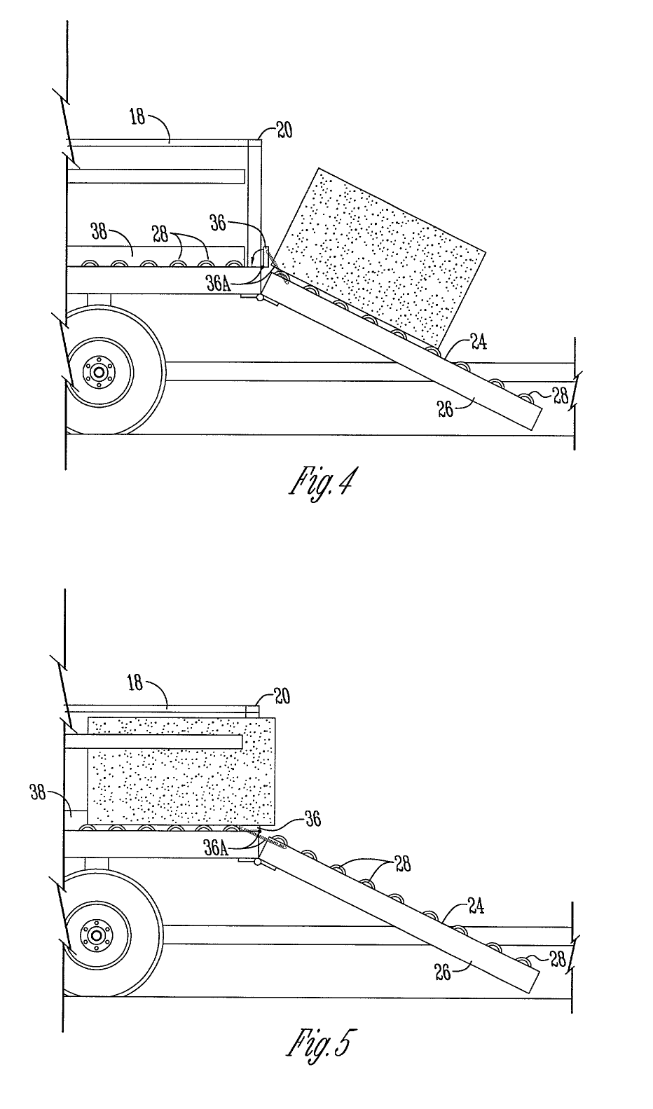

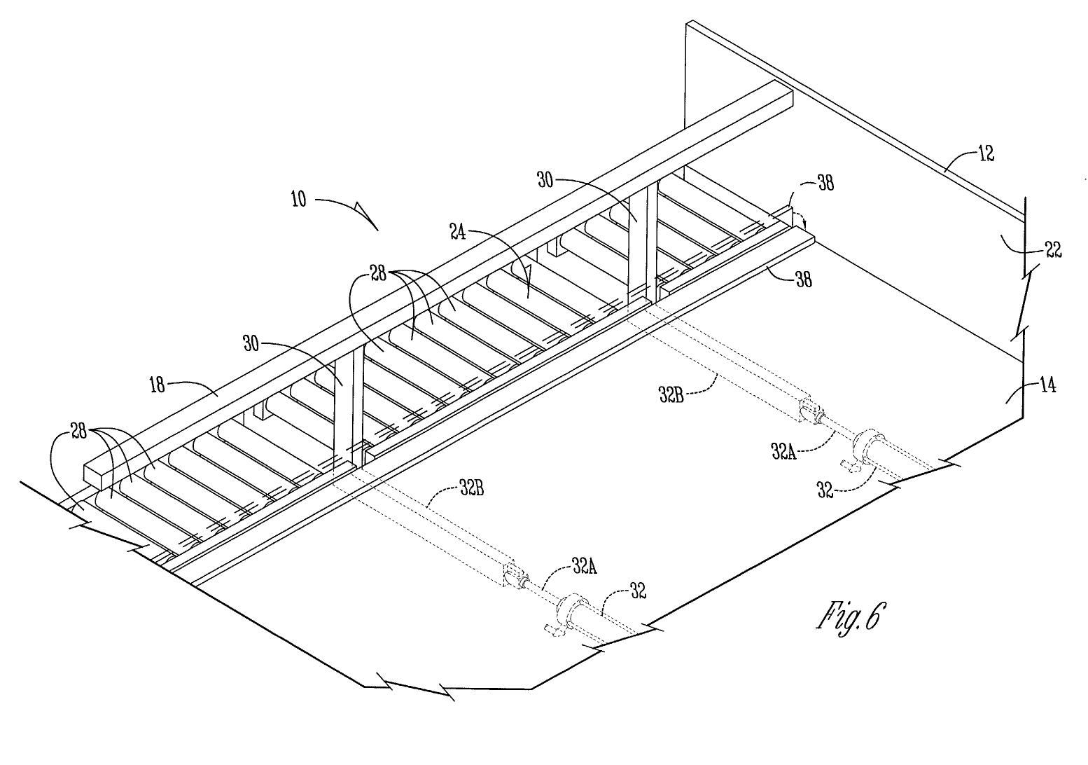

As shown in FIGS. 4 and 5, a spring loaded normally vertical check plate 36 is used to hold the bales on the deck portion of the track 24. The check plate 36 is positioned at the upper end 38 of the ramp 26 and is hingedly mounted to the track 24 such that the check plate 36 is movable between a vertical position (FIG. 4) and a horizontal position (FIG. 5). The check plate 36 is connected to the track 24 by a spring-loaded hinge assembly 36A (FIGS. 4 and 5) such that the check plate 36 is generally held in the vertical position. As hay bales are transported on the track 24 from the ramp 26 to the deck portion of the track 24, the hay bales engage the check plate 36 with sufficient force to move the check plate 36 from a vertical position of FIG. 4 to the down position of FIG. 5. When the hay bale has cleared the check plate 36, the spring loaded connection returns the check plate 36 to its vertical position.

A lateral check plate 38 (FIG. 6) extends along the inner edge 34 of the track 24 and is hingedly connected to the upper surface of the deck 12 for movement between a vertical position and a down position. The lateral check plate 38 holds the row of bales in alignment while positioned on the track 24. The lateral check plate 38 is connected to the deck 12 by a spring-loaded hinge (not shown) so that the lateral check plate 38 is generally held in a vertical position. When the side bar 18 is activated and moves the row of hay bales laterally, the hay bales engage the lateral check plate 38 with sufficient force to move the lateral check plate 38 from an up position to a down position. When the hay bale clears the lateral check plate 38, the spring-loaded hinge returns the lateral check plate 38 to the vertical position.

To unload the device 10, the tail gate 22 is moved to a down position which is generally in the same horizontal plane as the deck 14, and the deck 14 is raised at the front end by a conventional lifting means (not shown) such that the bales will slide off the back end. The lifting means can be of any conventional type including a hydraulic cylinder positioned at the front end and a hinged attachment at the back end.

Having thus described the invention it should be understood that numerous structural modifications and adaptations may be resorted to without departing from the spirit of the invention.

What is claimed is:

1. A hay bale pick-up device for loading hay bales comprising:
a trailer with a deck, a side wall, a front end, a tail gate, and a moveable side bar;
a powered track extending longitudinally along one side of the deck and having a front end terminating in an inclined ground engaging ramp for receiving the hay bales; and
a means for laterally moving the side bar across the track portion of the deck toward an inner edge of the track.

2. The device of claim 1 wherein the track is comprised of a plurality of spaced rollers.

3. The device of claim 1 wherein the means for laterally moving the side bar comprises a plurality of cylinders positioned below the deck and connected to the side bar.

4. The device of claim 1 wherein a check plate is hingedly mounted to an upper end of the ramp such that the check plate is held in an upward position and is moveable to a down position when engaged with sufficient force from the hay bale being transported on the track.

5. The device of claim 1 wherein a lateral check plate extends along the inner edge of the track and is hingedly mounted to the deck such that the lateral check plate is held in an upward position and is moveable to a down position when engaged with sufficient force by the hay bale when moved laterally by the side bar.

6. A hay bale pick-up device for loading hay bales comprising:
a trailer with a deck, a side wall, a front end, a tail gate, and a moveable side bar;
a powered track extending longitudinally along one side of the deck and having a front end terminating in an inclined ground engaging ramp for receiving the hay bales;
a means for laterally moving the side bar across the track portion of the deck toward an inner edge of the track; and
a check plate hingedly mounted to an upper end of the ramp such that the check plate is held in an upward position and is moveable to a down position when engaged with sufficient force from the hay bale being transported on the track.

7. The device of claim 6 wherein the track is comprised of a plurality of spaced rollers.

8. The device of claim 6 wherein the means for laterally moving the side bar comprises a plurality of cylinders positioned below the deck and connected to the side bar.

9. The device of claim 6 wherein a lateral check plate extends along the inner edge of the track and is hingedly mounted to the deck such that the lateral check plate is held in an upward position and is moveable to a down position when engaged with sufficient force by the hay bale when moved laterally by the side bar.

10. A hay bale pick-up device for loading hay bales comprising:
a trailer with a deck, a side wall, a front end, a tail gate, and a moveable side bar;
a powered track extending longitudinally along one side of the deck and having a front end terminating in an inclined ground engaging ramp for receiving the hay bales;
a means for laterally moving the side bar across the track portion of the deck toward an inner edge of the track;
a check plate hingedly mounted to an upper end of the ramp such that the check plate is held in an up position and is moveable to a down position when engaged with sufficient force from the hay bale being transported on the track; and
a lateral check plate extending along the inner edge of the track and hingedly mounted to the deck such that the lateral check plate is held in an upward position and is moveable to a down position when engaged with sufficient force by the hay bale when moved laterally by the side bar.

11. The device of claim 10 wherein the track is comprised of a plurality of spaced rollers.

12. The device of claim 10 wherein the means for laterally moving the side bar comprises a plurality of cylinders positioned below the deck and connected to the side bar.
